(19) United States
(12) Patent Application Publication
(10) Pub. No.: US 2024/0367288 A1
(43) Pub. Date: Nov. 7, 2024

(54) FINISHING METHOD AND FINISHING MACHINE FOR MEASUREMENT-ASSISTED FINISHING OF BORES

(71) Applicant: KADIA Produktion GmbH + Co., Nürtingen (DE)

(72) Inventor: Uwe Moos, Dettingen an der Erms (DE)

(73) Assignee: KADIA Produktion GmbH + Co., Nürtingen (DE)

(21) Appl. No.: 18/289,376

(22) PCT Filed: May 2, 2022
(86) PCT No.: PCT/EP2022/061728

§ 371 Date: Nov. 3, 2023

(30) Foreign Application Priority Data
May 10, 2021 (DE) 10 2021 204 724.6

(51) Int. Cl. B24B 49/04; G01B 7/13

(52) U.S. Cl. CPC B24B 49/04; G01B 7/13

(57) ABSTRACT

A finishing method for material-removing finishing of a bore in a workpiece on a finishing machine, wherein a finishing tool removes material from the inner surface of the bore in a finishing operation and a shape measurement of the inner surface of the bore is performed on the finishing machine before, during and/or after the finishing operation, the method including introducing a measuring tool into the bore and generating a relative movement between the measuring tool and the workpiece, detecting geometry-relevant measurement values by the measuring tool, and evaluating the measurement values in an evaluation operation to ascertain at least one shape measurement value describes the macro shape of the bore inner surface, wherein the evaluation operation includes: filtering the measurement values generated by the measuring tool using a filter criterion and at least one filter parameter to ascertain filtered measurement values.

### TECHNICAL FIELD

This disclosure relates to a finishing method and a finishing machine for material-removing finishing of a bore in a workpiece.

### BACKGROUND

A preferred field of application is the measurement-assisted finishing of bores by honing (internal honing), wherein a measurement (shape measurement) is carried out during and/or after the finishing to determine the macro shape of the bore.

Honing is a machining process with geometrically undefined cutting edges in which a honing tool performs a cutting movement consisting of two components and there is constant surface contact between one or more cutting material bodies, e.g., honing stones, of the honing tool and the inner surface of the bore to be machined. The kinematics of a honing tool is characterized by a superposition of a rotary motion and a linear motion running in the axial direction of the bore. In most situations, an optional expanding movement is also provided, which leads to a change in the effective diameter of the honing tool.

On the inner surface of the bore, the kinematics of the honing tool creates a surface structure with intersecting machining tracks. Surfaces finished by honing can meet extremely high requirements in terms of dimensional and shape tolerances. For this reason, many highly stressed sliding surfaces in engines or engine components, e.g., cylinder running surfaces in engine blocks or bore inner surfaces in injection pump housings, are machined by honing.

To be able to reliably and permanently withstand the loads of highly stressed workpieces at their place of use, the demands on the quality of the honed bores are increasing. Increasingly, the diameter of the bores must be reliably kept within tolerances of a few μm, and in some instances even below this. In addition, the macro shape of the bore must meet high quality requirements. For example, geometric requirements such as roundness of the bore, parallelism of the bore generatrices and cylindricity of the bores are demanded in the um range.

To be able to achieve the high accuracy requirements, measuring operations (one or more) are carried out in conjunction with the honing operation using a measurement system. In particular, during and/or after finishing, a measurement can be performed to determine the macro shape of the bore.

Known, for example, is the use of honing tools with integrated measuring nozzles of a pneumatic in-process measuring system, which can ascertain the current diameter of the bore (actual diameter) on the workpiece clamped in the machining position on the honing machine during the honing process and/or after individual honing stages. This value can be used to control the honing process, e.g., as part of a shutdown control.

Post-process measuring stations arranged separately from a machining station are also known. In a post-process measuring station, the bore diameter can be ascertained at several points in the bore and the information thus obtained can be linked together. In this way, in addition to the diameter information, information can also be obtained about the macro shape of the bore produced. Post-process measuring stations are often used primarily for quality control, i.e., to distinguish between good parts and bad parts. It is also possible to integrate a post-process measuring station into the control loop of a honing system and to use the measurement results to control upstream honing stages.

Nowadays, such measurements are often carried out using pneumatic measuring systems that work according to the nozzle-baffle principle and are known.

DE 10 2010 011 470 A1 describes a method and device for measurement-assisted finishing of bores, wherein radar radiation is directed onto the workpiece surface at at least one measuring position and the radar radiation reflected by the workpiece surface is detected and evaluated to ascertain at least one surface measurement value. Thereby, high measurement dynamics and high measurement accuracies are to be achievable. Distance measurements can be carried out at high sampling rates to contain information about the diameter and/or the macro shape of the bore inner surface and to ascertain therefrom, for example, information about dimensional accuracy, roundness, cylindricity and/or profiling in the axial direction (conicity, barrel shape, hourglass shape, bellmouth). Details of the evaluation of the measurement values are not disclosed.

EP 2 378 242 B1 describes a device for industrial measurement of bores having a measuring probe that can be inserted into the bore and on which at least one distance sensor is provided, with which the instantaneous distance of a reference point of the measuring probe from a wall of the bore can be determined. The measuring probe is rotatably mounted on a holder fixed relative to the measured object and/or the position of which relative to the measured object is known. The evaluation device is designed to receive a number of successively determined distances in the course of a rotation of the measuring probe. Furthermore, the device comprises means for determining the inclination of the measuring probe relative to the holder as well as correction means for compensating for inherent movements and misalignments of the measuring probe on the basis of the inclination. In addition to the measurement value, the position as well as the inclination of the measuring probe is also recorded since this has a strong effect on the measurement value in a system with only one measuring sensor. To determine the roundness, two concentric circles are calculated from the successive measurement values of a rotational movement. These are referred to as the maximum inscribed circle and the minimum inscribed circle, and their radial distance is used as a measure of the roundness of the bore.

It is also known to perform process monitoring of the quality of the honed bores in a separate precision measuring room downstream of production. On special measuring machines (e.g., coordinate measuring machines or so-called shape testers with rotatable workpiece receptacle), individual workpieces are examined for all critical features (diameter, bore shape, surface roughness). For this purpose, the workpieces are cleaned and temperature-controlled, the workpieces are measured and, if the required tolerances are met, the production batch is released for delivery or assembly or further processing.

There is nonetheless a need to provide a finishing method and a finishing machine for measurement-assisted material-removing finishing of a bore in a workpiece that makes it possible to systematically produce workpieces with bores that meet the highest macro shape requirements within relatively short times.

### SUMMARY

I provide a finishing method for material-removing finishing of a bore in a workpiece on a finishing machine, wherein a finishing tool removes material from the inner surface of the bore in a finishing operation and a shape measurement of the inner surface of the bore is performed on the finishing machine before, during and/or after the finishing operation, the method comprising introducing a measuring tool into the bore and generating a relative movement between the measuring tool and the workpiece, detecting geometry-relevant measurement values by the measuring tool, and evaluating the measurement values in an evaluation operation to ascertain at least one shape measurement value describes the macro shape of the bore inner surface, wherein the evaluation operation comprises: filtering the measurement values generated by the measuring tool using a filter criterion and at least one filter parameter to ascertain filtered measurement values; performing a curve fitting on the filtered measurement values to ascertain at least one fitting element adapted to the filtered measurement values in a reference element selected from the group consisting of reference circle, reference line, reference cylinder, reference cone, reference sphere and a combination of rotationally symmetrical portions of at least two of the reference elements; ascertaining the shape measurement value using at least one geometric property of the fitting element; and further processing the shape measurement value to operate the finishing machine.

I also provide a finishing machine that finishes a bore in a workpiece comprising: at least one work station having a tool carrier that carries a tool and a workpiece holding device that holds the workpiece in a working position of the work station; a control device that controls working movements of the tool carrier and/or the workpiece holding device; a measuring system that performs a shape measurement of the bore inner surface, wherein the measuring system has a measuring tool that can be inserted into the bore for detecting geometry-relevant measurement values, and the measuring tool is coupled or can be coupled to the tool carrier and can be moved relative to the workpiece by generating a relative movement between the measuring tool and the workpiece carrier; and an evaluation device that evaluates the measurement values detected by the measuring tool in an evaluation operation to ascertain at least one shape measurement value describing the macro shape of the bore inner surface; wherein the evaluation device is configured in at least one evaluation mode to perform steps in an evaluation operation: filtering the measurement values generated by the measuring tool using a predefined or predefinable filter criterion to ascertain filtered measurement values; performing a curve fitting on the filtered measurement values to ascertain at least one fitting element adapted to the filtered measurement values in a reference element, at least one selected from the group consisting of reference circle, reference line, reference cylinder, reference cone, reference sphere and a combination of rotationally symmetrical portions from at least two of the reference elements; ascertaining the shape measurement value using at least one geometric property of the fitting element; and processing the shape measurement value to operate the finishing machine.

### BRIEF DESCRIPTION OF THE DRAWINGS

FIG. 1 shows an example of a honing machine with integrated measuring station.

FIGS. 2A-2C schematically show steps and parameters of a Roundtree measurement.

FIGS. 3A and 3B schematically show steps and parameters of a straightness measurement.

FIG. 4 schematically shows parameters of a measurement of the cylindricity.

FIG. 5 schematically shows parameters of a measurement of parallelism.

FIG. 6 schematically shows an example of a parameter view for entering target values of a roundness measurement at the operating unit of a honing machine.

FIG. 7 schematically shows an example of a display of process details at the operating unit of a honing machine.

FIG. 8 shows a graphical display of multiple roundness measurements recorded in a bore, associated measurement values, and a control element for moving the display in space.

### DETAILED DESCRIPTION

My finishing method for finishing a bore in a workpiece is performed automatically on a finishing machine, i.e., on a machine tool set up for finishing. During the finishing operation, a finishing tool removes material from the inner surface of the bore in a finishing operation, for example, by honing or internal cylindrical grinding. Temporally before, during and/or temporally after the finishing operation, a shape measurement of the bore inner surface is performed on the finishing machine. For this purpose, a measuring tool is introduced into the bore by a relative movement between the measuring tool and the workpiece, and a relative movement is generated between the measuring tool and the workpiece.

The relative movement can be generated by the workpiece being still and the measuring tool being moved relative to the workpiece. It is also possible that the measuring tool is still while only the workpiece is moved. A combination with measuring tool moved at least in phases and workpiece moved at least in phases is also possible.

Geometry-relevant measurement values are detected by the measuring tool. The measurement values are then evaluated in an evaluation operation to ascertain at least one shape measurement value that describes the macro shape of the bore inner surface.

The measurement of the bore shape or the bore geometry therefore takes place in conjunction with a finishing the workpiece surface during which material is removed from the workpiece, for example, by machining. A measurement “on the finishing machine” means that the workpiece is located in a work station of the finishing machine for the measurement. The work station may be a machining station where machining also takes place, for example, by honing. The work station can also be a separate measuring station of the finishing machine, i.e., a work station that is set up specifically for the measurement and at which no machining takes place. In this example, a preferably automated transport or transfer between machining station and measuring station is provided.

In both examples, the workpiece is clamped in a workpiece holding device of the finishing machine for the measurement. If a transport between the machining station and a separate measuring station takes place between machining and measuring, the workpiece preferably remains clamped in the workpiece holding device so that no position errors caused by re-clamping can occur.

The evaluation operation is carried out in an evaluation device of the finishing machine. This can be an integral part of the control unit of the finishing machine and can be located either on site (locally) or remotely (connected to the control unit via remote data transmission). Especially for performance reasons, it may be useful to relocate the evaluation. Possible locations for this are, for example, the non-real-time side of the control device or an external evaluation device.

The measurement values of the measuring tool are initially unprocessed raw measurement values. The evaluation operation comprises several steps. In a filter operation, the measurement values (raw measurement values) generated by the measuring tool are subjected to filtering using a filter criterion and at least one filter parameter to ascertain filtered measurement values. The filter criterion and the at least one filter parameter can be fixedly predefined or, for example, variably predefined by the operator.

For example, a Gaussian filter, a robust Gaussian filter, a spline filter, a robust spline filter, or an RC filter can be used as a filter criterion.

For Gaussian filters, robust Gaussian filters and RC filters, the filter parameter is preferably a cutoff wavelength. This is then a frequency-dependent or wavelength-dependent filtering. The cutoff wavelength is the filter parameter that defines at which frequency the useful signal is separated from the interfering signal. The filter characteristic determines, among other things, how strongly signal jumps are handled.

For spline filters or robust spline filters, the curvature or stress of an interpolation curve is preferably defined as a filter parameter. Spline filters try to minimize the curvature of a curve interpolated between the measurement values to separate the useful signal from the interfering signal.

Since first-order shape deviations (straightness, roundness or the like) are substantially characterized by low frequencies and low curvatures, low-pass filters are preferably used for such measurements. It is also possible to use a high-pass filter or a combination of two similar filters with different filter parameters as bandpass or bandstop.

The filter operation provides filtered measurement values in which, compared to the unfiltered raw measurement values, e.g., local outliers can be eliminated as far as possible without filtering out the sought-after information on the macro shape.

In a subsequent step, a curve fitting is performed on the filtered measurement values to ascertain at least one fitting element adapted to the filtered measurement values. The type of fitting element corresponds to a reference element selected from the group of reference circle, reference line, reference cylinder, reference cone, reference sphere or a combination of portions of at least two of the reference elements such as truncated cone or spherical cap.

A reference element specifies the expected geometric character of the relationship of the measurement values and is specified. A reference element corresponds to a basic element of the geometry or a combination of basic elements or parts thereof. In this respect, the reference element only specifies the nature of the fitting element, but not its parameters such as size dimensions. A reference line is a one-dimensional reference element. A reference circle is a two-dimensional reference element in the form of a figure rotationally symmetrical to the center of the circle. Reference cylinder, reference cone and reference sphere, reference truncated cone and the like are examples of three-dimensional rotationally symmetrical reference elements.

The fitting element is the result of the curve fitting performed on the measurement values. A curve fitting (sometimes “fitting”) is a mathematical optimization method, with the help of which the unknown parameters of the geometric-physical model of a series of measurement values or measurement data or the parameters of a given function are to be determined or estimated for the series of measurement values or measurement data. The curve fitting is oriented to a (given) reference element, which represents the type of geometric relationship between the measurement values or measurement data. In a roundness measurement, for example, it is expected that the measurement values lie more or less well on a common circle. The reference element is thus a reference circle, and the associated fitting element is a circular fitting element, i.e., a fitting circle. The reference circle is independent of the actual dimensions of the bore. The fitting circle, on the other hand, results from the actual measurement values and accordingly has evaluable dimensions, e.g., a diameter.

In other words, reference elements describe abstractly possible elements in space, while the one specific element fitted to the respective data and defined in space is called a fitting element. A calculated fitting element is the element specifically defined in space by the curve fitting corresponding to the shape of the associated reference element.

To determine the roundness of the bore in a specified measuring plane, for example, a fitting circle is calculated from the filtered measurement values or the filtered profile. This fitting circle can be determined, for example, by the least-squares method. Other methods of the curve fitting are also possible, for example, the so-called ‘random sample consensus,’ which in simple terms attempts to eliminate outliers from the measurement data before the curve fitting is carried out according to the classical algorithm. For the determination of the straightness, a regression line is ascertained accordingly by the curve fitting, e.g., by linear regression according to the least-squares method.

The shape measurement value is then ascertained using at least one geometric property of the fitting element. The fitting element ascertained by curve fitting on filtered measurement values thus serves as the basis or comparison variable in ascertaining the shape measurement value.

The ascertained shape measurement value is then further processed for the operation of the finishing machine. In simpler examples, further processing can consist of displaying the ascertained shape measurement value visibly to an operator and/or storing it digitally together with other workpiece-specific data. It is also possible to modify the parameters of the control of the finishing operation on the basis of the shape measurement value. It is also possible to classify the measured workpiece, e.g., into good parts (where the bore shape corresponds to the nominal shape within predefined tolerances) and bad parts, which are outside the tolerances. In bad parts, it can be provided that the respective workpieces are automatically ejected from the production process if they are classified as bad parts.

I also provide a finishing machine for finishing a bore in a workpiece, the evaluation device of which is configured in at least one evaluation mode to perform an evaluation operation of my method. Such a finishing machine comprises at least one work station having a tool carrier and a workpiece holding device for holding the workpiece in a working position of the work station. Furthermore, a control device that controls working movements of the tool carrier and/or the workpiece holding device is provided. The finishing machine further comprises a measuring system that performs a shape measurement of the bore inner surface. In the ready-to-operate, set-up state, the measuring system has a measuring tool that can be inserted into the bore to detect geometry-relevant measurement values. In the ready-to-operate state, the measuring tool is coupled to the tool carrier and can be moved relative to the workpiece by working movements of the tool carrier and/or the workpiece carrier, controlled via the control system of the finishing machine. An evaluation device of the finishing machine is used to evaluate the geometry-relevant measurement values detected by the measuring tool in an evaluation operation to ascertain at least one shape measurement value describing the macro shape of the bore inner surface.

The tool carrier may be a movably mounted work spindle that can be rotated about a spindle axis by a rotary drive and moved parallel to the spindle axis by a linear drive.

The shape measurement, i.e., the measurement of the macro shape, can be carried out using standard measuring equipment already used on the finishing machine, e.g., for wear compensation so that no additional tool costs are incurred here.

The measuring method for the shape measurement, with regard to the measurement value recording, can correspond to the method for the diameter evaluation for the compensation of the tool wear so that it is prevented that a measurement difference arises here, for example, due to the influence of the surface topography.

In some examples, the measurements are carried out using a pneumatic measuring system, which may also be referred to as an “air measuring system” and operates according to the nozzle-baffle principle. In these systems, compressed air flows from measuring nozzles in the direction of the bore wall. The resulting dynamic pressure in the region of the measuring nozzles serves as a measure of the distance between the measuring nozzle and the bore wall. The bore diameter can be ascertained by two diametrically opposed measuring nozzles. Pneumatic measuring systems allow non-contact measurement independent of the material of the measured object and, within their measuring range, high measurement accuracies in the order of a few micrometers. In in-process measurements, the measuring nozzles are integrated into the finishing tool. In post-process measurements, they can be mounted in a special measuring mandrel.

The measuring method constituted of pneumatic dynamic pressure measurement, for example, records the arithmetic mean value of the surface roughness as a reference point, while a tactile method, which is also possible, tends to record the peaks of the roughness profile, depending on the size of the probe.

The evaluation of the measurement values on the finishing machine is partly based on the evaluation of the measurement in the precision measuring room. This ensures a high degree of comparability of the measurement values since signal processing during measurement in the um range can also have an influence on the measurement results. The filtering of the raw measurement values ensures that no “outliers” occur in the measurement result due to signal fluctuations. The evaluation according to mathematical methods leads to the fact that the measurement results represent the real existing bore shape sufficiently correctly. In particular, by referring to a fitting element (for example, a fitting line, a fitting circle, a fitting cylinder, a fitting cone or the like), more accurate measurement results can be obtained than if the measurement values were referred to the center of a measuring device.

Compared to measurement in a separate precision measuring room, measurement on the finishing machine can be carried out quickly since unloading from the finishing machine, cleaning and temperature control of the workpieces, and alignment on the measuring machine are not required. For example, the measurement on the finishing machine can be carried out within a few seconds, while 30 minutes can easily be required for a measurement in the precision measuring room.

Measurement under production conditions eliminates additional dimensional deviations that can occur, for example, due to temperature differences between the machining condition and the precision measuring room.

While downstream measurement of bores in the precision measuring room is associated with high costs of measuring machines and qualified personnel as well as a time delay due to the necessary cleaning and temperature control of the workpieces as well as the usually quite high measuring time, the integration of a shape measurement (measurement of the macro shape of the bore) into a production machine offers a high added value. The measurement results are available practically immediately during ongoing production so that a quick response can be made if there are qualitative deviations. Fast and direct monitoring on the production machine can reduce the number of workpieces to be measured in the precision measuring room at high cost.

In the precision measuring room, usually only the finished bores are measured after the last machining operation. However, due to the time delay for the measurement in the precision measuring room, work is usually already continuing on the machine so that it is very time-consuming to obtain measurement values for one and the same workpiece or to detect measurement values from bores that have not yet been machined on all machining operations and then to continue machining this workpiece. By integrating the measurement into a production machine, all machining operations can additionally be monitored during running operation.

In numerous examples, an ascertaining of roundness values is provided. Such method variants comprise a rotation of the measuring tool about a measuring tool rotation axis during the measuring operation for ascertaining measurement values along a circumferential direction of the bore in at least one measuring plane, as well as an ascertaining of a roundness value from the measurement values. Unlike many shape testing machines, the workpiece is still during the measuring operation while the measuring tool rotates. To determine the roundness of the bore, a fitting circle is calculated from the filtered profile. This fitting circle can be determined by the least squares method, for example.

Preferably, the roundness value is ascertained by calculating a fitting circle using the filtered measurement values (by a curve fitting) and determining a smallest radius and a largest radius relative to the center of the fitting circle. The roundness value can then be defined, for example, as the difference between the largest and smallest radius. The smallest circle concentric to the center of the fitting circle outside the measurement values should be referred to as the minimum inscribed circle or outer circle. The largest circle concentric to the center of the fitting circle which lies within the measurement values shall be referred to as the maximum inscribed circle or inner circle. The radius difference of the concentric minimum inscribed circles and maximum inscribed circles can be used as a measure of roundness or as a roundness value.

With this variation of my method, the center of the reference circle usually differs from the center of the measuring system as soon as there is a deviation from an ideally round bore. The measuring method is therefore particularly sensitive to roundness deviations. At the same time, this method variant is particularly well adapted to measurement value acquisition on the finishing machine since, in contrast to EP 2 378 242 B1, it is possible to dispense with determining any inclination of the measuring tool with respect to an ideal axis of rotation. In other words, the exact position and orientation of the axis of rotation of the measuring tool need not be known in this approach. The position of the center of the reference circle determined by curve fitting is only determined by the curve fitting. This procedure is particularly well adapted to measurement on the finishing machine.

As an alternative or in addition to a roundness measurement, it is also possible, for example, to measure eccentricity. For this purpose, the center of the fitting circle is determined in relation to the (stationary) axis of rotation of the measuring tool. Eccentricity can be characterized or quantified by the distance and direction of the deviation. Such a measurement can be useful if, for example, the position of a machined bore in relation to the stationary axis of rotation) is to be detected.

At least one straightness value may be determined alternatively or additionally to the ascertaining of at least one roundness value. Such an example is characterized by an axial relative movement between the measuring tool and the workpiece, e.g., by an axial movement of the measuring tool parallel to the spindle axis and thus also to the axial direction of the bore, during the measuring operation to ascertain measurement values along an axis-parallel generatrix and ascertaining a straightness measurement value from these measurement values. The measurement values are thus ascertained by a scan along the inner surface of the bore parallel to the axis of the bore. Filtering can be performed in the same way as for roundness measurement. In contrast to the roundness measurement, however, the reference element is not a fitting circle, but a fitting line. The straightness value can be defined, for example, as the distance between two straight lines of minimum distance parallel to the fitting line, which enclose all measurement values.

One advantage of measuring on the finishing machine is that, for roundness measurements, the rotary position of the measuring tool can be derived from the encoder position of the rotary drive and/or, for straightness measurements, the axial position of the measuring tool can be derived from the encoder position of the linear drive of the work spindle of the finishing machine. This means that it is not necessary to install additional measurement technology such as a separate rotary encoder or displacement encoder.

Alternatively or additionally, a cylindricity value can be ascertained. This can be derived, for example, from the ascertained roundness value and an ascertained straightness value. The cylindricity value can be defined, for example, as the distance between two coaxial cylinder surface areas of minimum distance that include all measurement values. As an alternative to calculating the cylindricity from the calculated roundness and straightness measurement values, it is also possible to calculate it directly from the filtered rotational and linear measurement values using a cylindrical reference element.

A parallelism value can be calculated from two axis-parallel individual measurements opposite each other on the bore surface. This can be done, for example, by using a single measurement to calculate a fitting line, while the two parallel lines of minimum distance must include the measurement values of the second single measurement at a diametrically opposite bore generatrix.

A cone measurement can also be performed to ascertain a cone value. The cone value can represent, for example, a cone angle of the bore or in a conical portion of the bore.

Preferably, a diameter measuring tool with at least one pair of diametrically opposed measuring probes is used as the measuring tool. The term “diameter measuring tool” refers to a measuring tool suitable for diameter measurement. This includes, among other things, pneumatic measuring mandrels with two measuring nozzles diametrically opposite the measuring mandrel axis and a common measuring channel that transmits the measurement information of both measuring nozzles in the direction of the transducer and the evaluation device. In particular, a dedicated pneumatic measuring tool without tool parts can be used for material removal.

It is also possible for the measuring probes to be integrated into a finishing tool so that this is a combined finishing and measuring tool.

It is accepted that certain shape deviations (for example, in the form of a triangular or egg-shaped shape error) cannot be fully detected in measuring devices having several sensors (for example, in a pneumatic measuring mandrel with two opposing measuring nozzles). Generally speaking, roundness errors of which the order is one level lower or higher than the number of measuring sensors are not fully detected. Also, a curvature of the bore along the bore axis cannot be fully detected by a measuring mandrel having multiple nozzles. This limitation is offset, among other things, by the benefit that measurements require only a small amount of measuring time and mechanical components. This means that the measurement can be used directly during production and additionally on operations prior to finishing.

The measuring probes do not have to operate pneumatically. Other operating principles are also possible, e.g., capacitive measuring probes, eddy current measuring probes operating by induction or radar measuring probes.

Preferably, the measuring tool is rigidly coupled to a work spindle of the finishing machine. The rigid coupling is used, among other things, to prevent compensating movements of the measuring means that could negatively influence the measurement values.

A further advantage of the integration of shape measurements into a finishing machine is that all machining operations can be monitored during operation. In some examples, it is also envisaged to ascertain a temporal development of at least one shape measurement value by offsetting at least two similar measuring operations performed at different times. For example, certain workpieces can be tracked across all machining operations with respect to the roundness development of the machined bore. The same applies to the development over time of straightness or other shape measurement values, for example, parallelism or cylindricity. Among other things, this has the advantage that it is possible, for example, to estimate whether there is a fluctuation in the measurement values over time or a trend in one direction. It is also possible to observe how a batch change of the workpiece pre-machining or a process intervention affects the measurement values.

Preferred examples of finishing machines configured and operable in accordance with my methods are characterized by an operator control device that operates the finishing machine, wherein in an operating mode which may be called, for example, “shape measurement,” an operator query for entering at least one item of information suitable for setting up the shape measurement can be generated or is generated. For example, a desired measurement mode may be entered. For example, at least one of the following measurement modes can be selected: cylindricity measurement, roundness measurement, parallelism measurement, straightness measurement, conicity measurement, bellmouth or constriction measurement and the like.

Furthermore, a filter criterion (e.g., Gaussian filter or spline filter) and a matching filter parameter (e.g., at least one cutoff wavelength for selected Gaussian filter) can be queried.

Preferably, results of the shape measurement can be displayed in a suitable form on a display device of the finishing machine, e.g., as numerical values and/or as an easily detectable graphic.

As a rule, workpieces are machined on a finishing machine to a fixed target diameter specified, for example, by a technical drawing. As a variation of the method to this “target dimension honing,” so-called “pairing honing” also exists. In pairing honing, the workpiece is not machined to a fixed target diameter, but the workpiece is “paired” to a special counterpart. For this purpose, the geometry of the counterpart is measured and the workpiece to be machined is then honed, for example, a few um larger than the largest diameter of the counterpart. This pairing honing is used in particular where a narrow clearance must be achieved between the workpiece and the counterpart, for example, a piston. However, the pistons themselves (e.g., due to a coating process) may have a variation in the outer geometry that significantly exceeds the tolerance of the resulting clearance.

To measure the geometry of the pistons, a so-called “piston measuring station” can be used, which can be mounted on the finishing machine. It has a stationary ring-shaped measuring tool with inward-pointing measuring nozzles. The piston is moved axially through this measuring tool. The diameter is measured at one or more defined points or over the entire outer contour. A piston diameter generated from this piston geometry is used to adapt the nominal values of the honing operation(s) and the bore measuring operation(s) to the respective piston diameter.

In contrast to measuring the shape of the inner surface of a bore, a substantially rotationally symmetrical outer surface of a workpiece is thus measured. The workpiece is moved to guide it into the measuring tool. Apart from these differences, evaluation of the measurement results can be carried out in the same way as described so far.

Thus, I also provide a finishing method for the material-removing finishing of a bore in a workpiece on a finishing machine, wherein a finishing tool removes material from the inner surface of the bore in a finishing operation and a shape measurement of the outer surface of a counterpart provided for insertion into the bore is carried out before and/or during the finishing operation by positioning the counterpart in an annular measuring tool and generating a relative movement between the measuring tool and the counterpart, geometry-relevant measurement values are detected by the measuring tool, and the measurement values are evaluated in an evaluation operation to ascertain at least one shape measurement value describing the macro shape of the outer surface. The measurement values can be evaluated according to the claimed evaluation operation.

I further provide a finishing method for material-removing finishing of a bore in a workpiece on a finishing machine, wherein a finishing tool machines the inner surface of the bore by removing material in a finishing operation and a shape measurement of a substantially rotationally symmetrical workpiece surface (bore inner surface and/or outer surface of a counterpart) is carried out before, during and/or after the finishing operation by bringing a measuring tool into measuring engagement with the workpiece and generating a relative movement between the measuring tool and the workpiece, geometry-relevant measurement values are detected by the measuring tool, and the measurement values are evaluated in an evaluation operation to ascertain at least one shape measurement value describing the macro shape of the workpiece surface, characterized in that the evaluation operation comprises: filtering the measurement values generated by the measuring tool using a filter criterion and at least one filter parameter to ascertain filtered measurement values; performing a curve fitting on the filtered measurement values to ascertain at least one fitting element adapted to the filtered measurement values in the manner of a reference element from the group of reference circle, reference line, reference cylinder, reference cone, reference sphere or a combination of rotationally symmetrical portions of at least two of the reference elements; ascertaining the shape measurement value using at least one geometric property of the fitting element; and further processing the shape measurement value to operate the finishing machine.

The measured workpiece can be the workpiece provided with the bore and/or a counterpart matching the bore, e.g., a piston.

Further advantages can be found in the description of examples explained below with reference to the figures.

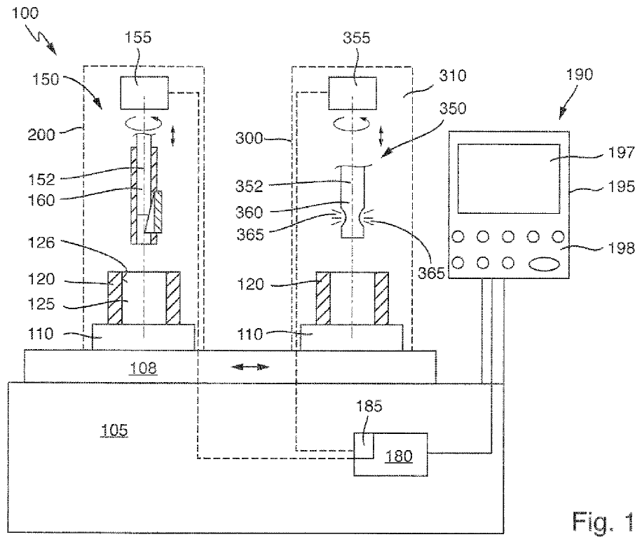

FIG. 1 schematically shows a finishing machine 100 configured as a honing machine that can be used in the context of various examples of my methods for finishing of inner surfaces of bores in workpieces, to perform one or more honing operations on the workpiece in a conventional manner and also to perform shape measurements on the same workpiece without re-clamping the workpiece.

A honing station 200 and a separate measuring station 300 are constructed on the machine bed 105 of the honing machine. At the machining station set up as a honing station, there is a workpiece holding device 110 in which a workpiece 120 is clamped. The workpiece contains at least one bore 125, the inner surface 126 of which is to be finished by honing to bring the macro shape of the bore close to a desired shape within the manufacturing tolerances and, at the same time, to produce a desired surface microstructure on the inner surface, which can be characterized, for example, by roughness parameters.

A machine-internal workpiece transport system 108, which can be equipped, for example, with a rotary indexing table or with linear workpiece transfer, is used to transport a finished honed workpiece from the honing station 200 to the measuring station 300 of the honing machine 100. For this purpose, the workpiece remains clamped in the workpiece holding device 110 and is transported together with the latter to the measuring station by machine-internal transport.

The honing station has a honing unit 150. The honing machine 100 can have a plurality of substantially identically constructed honing stations or honing units that can be used alternately or simultaneously in workpiece processing.

The honing unit 150 has a drive device 155 with a rotary drive and a linear drive that controls the working movement of a work spindle at the lower end of which is a tool holder for coupling an exchangeable honing tool 160. This can be rigidly or articulatedly coupled and can have a single honing strip or several honing strips or other types of cutting material bodies. The linear drive can be used to move the work spindle axially back and forth parallel to the axis of rotation, and the rotary drive can be used to rotate the work spindle about the axis of rotation 152 at predefinable rotational speeds or speeds of revolution. The honing unit also comprises a feed device with an expansion drive for controlling the radial expansion of honing tools.

The rotary drive (spindle drive), the lifting drive and the expansion drive are connected to a control device 180, which is a functional component of the machine control system. The control device 180 contains, among other things, devices for signal processing when interacting with actuators and sensors of the honing machine. These communicate with the control device via input/output interfaces. The control device can be operated via a user interface 195 of an operator control device 190. In the example, the operator control device 190 comprises a display or screen 197 and a keypad 198 and forms the operating interface or human-machine interface (HMI) of the honing machine, which enables the user to communicate with the honing machine.

The following process parameters, among others, can be set via the operator control device 190: position of the upper reversing point and the lower reversing point of linear movements. This allows the stroke length and the stroke position to be defined. Speed as well as speed characteristics in the reversing points (different characteristics due to honing with or without speed reduction in the region of a reversing point), feed speed, stroke speed, start of a honing phase, short strokes, dwell times of the stroke, maximum and minimum spindle torques and cutting pressures for monitoring the machining process and the like.

The measuring station 300 comprises components of a measuring system 310. Some mechanical components of the measuring system 310 are attached to a support structure in the form of a vertical stand that is mechanically fixed to the machine frame 105 of the finishing machine.

The workpieces of which the bores (one or more) are to be measured with the aid of the measuring system are transported to the measuring station with the aid of the workpiece transport system 108 and then transported away. The workpiece 120 is held in a workpiece holding device 110, which was also used during the processing at the honing station.

The measuring system 310 comprises a vertically oriented measuring unit 350, which in the illustrated, ready-to-operate state has a (replaceable) measuring mandrel 360 attached to the lower end of a work spindle and can be moved back and forth or up and down along a substantially vertical travel path parallel to a measuring mandrel axis 352 with the aid of a linear drive of a drive unit 355. The measuring mandrel is optionally additionally rotatable about the measuring mandrel axis by a rotary drive of the drive unit 355. Via the rotary drive, it is possible to perform measurements in any radial directions of the bore to be measured one after the other in time. The measuring mandrel is rigidly coupled to the work spindle of the measuring station to prevent compensating movements of the measuring means that could negatively influence the measurement values.

All working movements are controlled with the aid of the control unit 180 of the honing machine. This also includes components of an evaluation unit 185 that evaluates the measuring signals of the measuring unit.

In the example, the measuring mandrel 360 is a pneumatic measuring mandrel. In the lower end region, it has at least one pair of measuring nozzles 365 arranged diametrically opposite one another at a known fixed distance from one another in relation to the measuring mandrel axis 352. There are, for example, also measuring mandrels with three measuring mandrels (e.g., for parts with transverse bores in 3-pitch), 4-nozzle measuring mandrels (thus no influence of an ovality) and measuring mandrels with six or eight measuring mandrels (e.g., for very narrow webs). In all examples, the measurement value on the measuring mandrel corresponds to the mean value of the respective distances of the measuring nozzles to the workpiece surface.

Pneumatic measuring mandrels are known to work according to the nozzle-baffle principle. For the measurement, compressed air is blown out of the measuring nozzles in the direction of the bore wall. The resulting dynamic pressure in the region of the measuring nozzles serves as a measure of the distance between the measuring nozzle and the bore wall. A transducer connected to the measuring nozzle via a pressure line converts the (pneumatic) pressure signal into a signal that can be processed electrically. By two diametrically opposed measuring nozzles, the bore diameter can be ascertained for a given diametrical distance between the measuring nozzles. The position of a measuring nozzle is regarded here as the effective position of the measuring sensor.

Measurements of the macro shape of the bore 125 can be performed at the measuring station 300. For this purpose, the evaluation device 185 is configured in at least one evaluation mode to ascertain at least one shape measurement value from the measurement values of the measuring tool (measuring mandrel 360) that indicates a quantitative measure of the macro shape of the inner surface of the bore. In particular, indications for the roundness of the bore, the parallelism of the bore generatrices, the cylindricity or a conicity of the bore (i.e., the deviation from an ideal cone (frustum)), can be ascertained. Macro shapes with combinations of these can also be measured, e.g., for bores with a funnel shape, bottle shape, barrel shape, or bellmouths at axial ends. A bellmouth or constriction measurement detects a radius or tapered shape deviation at one or both ends of the bore, wherein constrictions at both ends corresponds to a barrel shape of the bore and bellmouths at both ends corresponds to an hourglass bore. Using roundness measurement as an example, procedures are explained below.

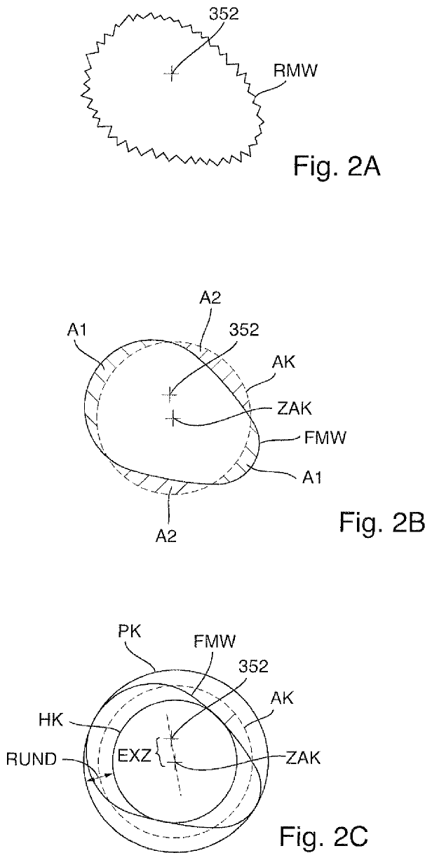

For a roundness measurement, the measuring mandrel is rotated about its axis of rotation in at least one measuring plane of the bore. First, (unfiltered) raw measurement values RMW are ascertained, the distribution of which with respect to the center of the measuring system (axis of rotation 352 of the mandrel 360) can look, for example, as shown in FIG. 2A. The raw measurement values are then further processed using a digital filter to somewhat smooth the raw measurement values, but without eliminating the roundness information sought. The filtering is performed using a filter criterion and a filter parameter that can be specified. For example, a Gaussian filter, a robust Gaussian filter, a spline filter, a robust spline filter, or an RC filter can be used as the filter criterion. In the example, a Gaussian filter is used in conjunction with at least one cutoff wavelength as a filter parameter. Processing using a high-pass filter, a low-pass filter or a band-pass filter is possible, for example. For a roundness measurement, a low-pass filter is expediently selected to eliminate high-frequency signal components that are predominantly due to surface roughness or disturbances in the signal detection, e.g., due to thermal noise, but to retain the low-frequency signal components that are representative of the macro shape for further evaluation. The passband characteristic at a predefinable cutoff wavelength can be, for example, 50% or 75%. The cutoff wavelength can be predefined depending on the diameter of the measured bore. For example, a Gaussian filter with 50% passband and a cutoff wavelength of 15, 50, or 150 waves/rev can be used. FIG. 2B shows an example of filtered measurement values FMW that are less noisy than the underlying raw measurement values RMW.

To determine the roundness of the bore, a fitting circle AK is calculated by the filtered measurement values FMW in a next evaluation step. This fitting circle AK can be determined, for example, by the least-squares method. This means that the radius of the fitting circle as well as the position of its center ZAK are chosen such that the area outside the fitting circle bounded by the measurement values each corresponds to the corresponding area inside the fitting circle. In other words, the fitting circle AK can be calculated such that the area A2 outside the measurement values, which is bounded by the fitting circle AK, has the same area as the area Al inside the measurement values, which is also bounded by the fitting circle. FIG. 2B shows an example.

A characteristic of this evaluation is that the center ZAK of the fitting circle AK usually differs from the center of the measuring system (i.e., from the position of the rotation axis 352 of the measuring mandrel) as soon as there is a deviation from an ideally round bore. The smallest circle concentric to the center of the fitting circle outside the measurement values is called here the minimum inscribed circle HK. The largest circle concentric to the center of the fitting circle, which lies within the measurement values, is referred to here as the maximum inscribed circle PK. The radius difference between the minimum inscribed circle and the concentric maximum inscribed circle is used here as a measure of the roundness RUND (FIG. 2C).

This difference can be used to perform an eccentricity measurement based on a roundness measurement. For this purpose, the centerpoint or center ZAK of the fitting circle is determined in relation to the (stationary) axis of rotation of the measuring tool. The distance EXZ between the centers can be used to quantify the eccentricity. Such a measurement can be useful, for example, if the position of a machined bore in relation to the stationary axis of rotation is to be recorded.

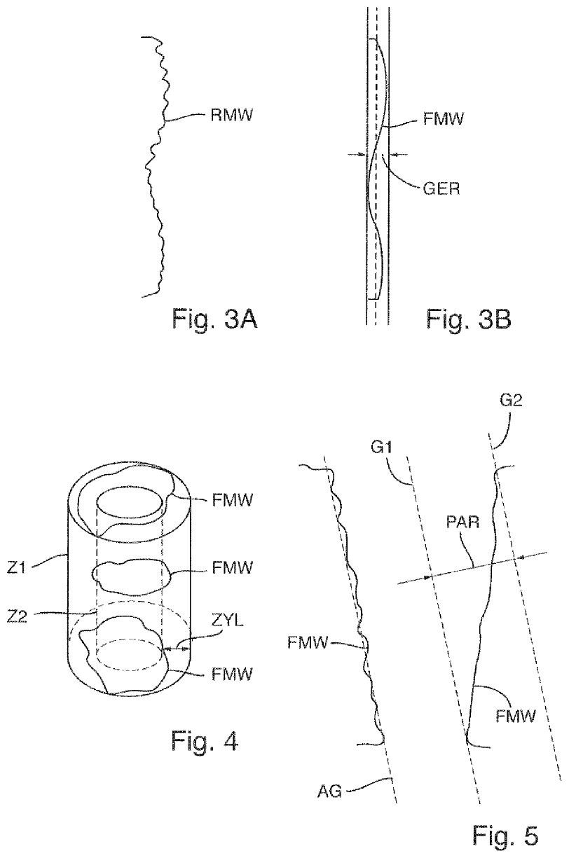

In addition to a roundness measurement, the measuring system and its evaluation unit are also capable of performing a straightness measurement of a bore lateral surface parallel to the bore axis. For this purpose, the measuring mandrel is moved in the bore parallel to the bore axis without internal rotation and measurement values are recorded for a predefinable rotary position of the measuring mandrel 360 in dependence on the axial position. The raw measurement values RMW ascertained in this way (FIG. 3A) are then processed in the same way as for ascertaining the roundness. Filtering to ascertain the filtered measurement values FMW (FIG. 3B) is performed in the same way as for the roundness measurement, but here the reference element is not a fitting circle but a fitting line AG. The measurement value GER for the straightness then corresponds to the distance between two straight lines of minimum distance parallel to the fitting line, which enclose all (filtered) measurement values (FIG. 3B).

The parallelism PAR can also be calculated from two axis-parallel individual measurement paths opposite each other on the bore lateral surface by using one measurement to calculate a fitting line AG adapted to the filtered measurement values FMW, while the two parallel lines G1, G2 of minimum distance must include the measurement values of the second measurement (FIG. 5).

The measuring system is also set up to calculate a cylindricity measurement value from several roundness and straightness measurements. This describes the distance between two coaxial cylinder lateral surfaces Z1, Z2 of minimum distance, which include all filtered measurement values FMW (cf. FIG. 4).

These exemplary evaluations on the finishing machine are based on corresponding evaluations of measurements in a precision measuring room. This ensures a high degree of comparability of the measurement values since signal processing can also have an influence on the measurement results when measuring in the micrometer range. The filtering of the raw measurement values ensures that no outliers occur in the measurement result due to signal fluctuations. Nevertheless, the evaluation according to mathematical methods leads to the fact that the measurement results represent the real existing bore shapes correctly. In particular, by referring to the fitting elements (for example, the fitting line or the center of the fitting circle), more accurate measurement results are obtained according to my experience of the-than if the measurement values are referred to the center of the measuring device (i.e., to the position of the axis of rotation of the measuring mandrel).

Compared to an external measurement, e.g., in a precision measuring room, a measurement on the finishing machine can be carried out relatively quickly since unloading from the finishing machine, cleaning and temperature control of the workpieces, and alignment on the measuring machine are not required. Measurements can be carried out in the order of magnitude of 15 s on the processing machine, for example, while measurements in the precision measuring room typically require at least 30 min.

Measurement under production conditions eliminates additional dimensional deviations that can occur, for example, due to temperature differences between the machining condition and the precision measuring chamber.

Compared to a measurement of the ovality of the bore using a measuring mandrel with a fixed rotational position and two pairs of nozzles diametrically offset by 90° to each other on two measuring channels, the roundness measurement of the type described here ensures that a narrow point or bulge located between the pairs of measuring nozzles is also found.

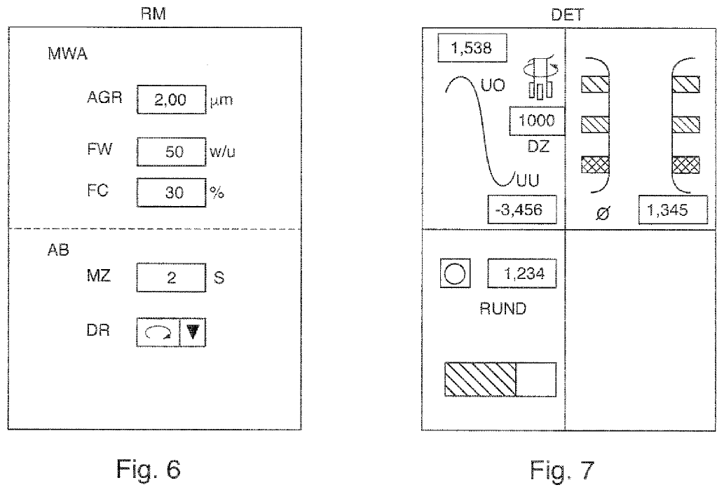

The measurement parameters preferred for a planned measurement can be conveniently entered by an operator at the operator control device 190. FIG. 6 shows an example of a parameter view for entering nominal values of a roundness measurement RM. Above the dashed line are inputs of the category “measurement value preparation” MWA. Parameter AGR describes the reject limit in micrometers. This means that workpieces with a roundness error that exceeds this limit are discarded as bad parts. Parameter FW specifies the number of filter waves per revolution (W/U). The fewer waves specified, the stronger the smoothing effect. Conversely, the higher the number of filter waves, the more visible the surface microstructure in the filtered measurement values. The parameter “filter characteristic” (FC) indicates to what percentage value the amplitude of the original signals has decreased at the filter wavelength FW. This parameter can be used to describe the slope or attenuation of the filter in the transition range. The higher the percentage value, the “smoother” is the transition between the transmitted and the filtered signal amplitudes near the filter wavelength FW.

Under the category AB (axis movements) the measuring time in seconds per measuring plane can be entered in the field MZ (measuring time). Parameter DR concerns the direction of rotation of the work spindle for the measurement.

With the aid of this operating window, an operator can conveniently specify the measurement characteristics of the subsequent roundness measurement. For the measurement of other form parameters (for example, straightness, cylindricity and the like) analog input masks are generated by the operating system.

FIG. 7 shows an example of a typical display of process details DET. Based on this, an operator can get an impression of the quality of the workpiece that the honing station has honed and the measuring station has measured. In the upper left quadrant, honing parameters are visible, namely the position of the upper reversing point UO, the position of the lower reversing point UU, and the spindle speed DZ. In the upper right quadrant, an exemplary diameter visualization is given through which the character of the bore is visible at a glance. For three spaced measurement planes (top, middle, bottom), colored bars are used to qualitatively compare the diameter values with nominal diameter values. While the two upper diameter measurement values lie within the tolerance range and are displayed in green accordingly, the lower diameter measurement value appears in yellow, indicating a tendency to leave the tolerance range. The numerical value below indicates the resulting average value for the bore diameter.

In the lower left quadrant, the roundness measurement value RUND (in micrometers) is displayed, which was ascertained by the previously described roundness measurement. Below this is a color bar that can optionally indicate tool wear or a comparison of the roundness measurement value with a nominal value. As long as the bar appears green, tool wear and/or the roundness measurement value are not critical. A color change to yellow indicates a tendency to leave the tolerance; with a red color bar the tool wear and/or roundness is outside the tolerances.

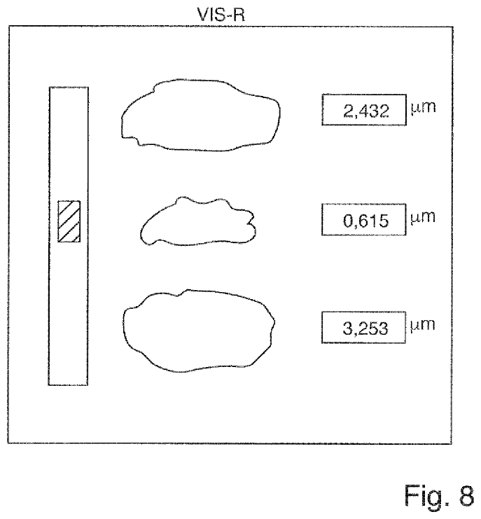

If an operator wishes to obtain a memorable visual impression of the measured roundness after completing a roundness measurement, they can switch to the visualization of roundness (VIS-R) shown in FIG. 8. There, the more or less circular distribution of roundness measurement values in three planes is displayed in the middle area in oblique perspective. The upper circle represents the roundness near the upper end of the bore, which is indicated in micrometers in the number field on the right. The same applies to the lower end of the bore and to the roundness centered in the workpiece between the axial ends. The specified sizes of the individual roundness result in the total roundness RUND. It can also be seen at a glance that the bore of the example is slightly waisted inward.

The left part of the image field shows a slider with a virtual actuation button that can be moved up or down at a specific position by wiping across the screen or by way of a touch gesture to change the perspective of the display. The central position results in a viewing direction substantially perpendicular to the bore axis. Moving to the upper or lower end position allows a view more or less parallel to the bore axis. The intermediate positions can be adjusted continuously.

The possibility of shape measurement on the finishing machine offers a whole range of additional advantages and possibilities. It can be particularly advantageous to carry out time-critical sequences not with every workpiece, but only after a defined interval and after critical events (for example, change of honing tool, longer machine downtime, several rejects in succession) and/or on request by the operator. This saves cycle time and at the same time ensures that all measurement values are always detected when required.

If the interval can be freely parameterized, this offers further advantages. If the fluctuation range of the measurement results is smaller, a larger interval can be specified until the next measurement. If the fluctuation range of the measurement results is high and, in addition, the distance to the tolerance limit is small, then a lower interval should be selected. The lowest interval means that every bore is measured.

An optional synchronization of all operations leads to the fact that in a single measurement to be carried out only after the measuring interval has expired, all measurements are reliably carried out in parallel (instead of only one measurement being carried out at different times at several operations while the other stations are waiting). This has the advantage that the cycle time of the machine only rarely has to be extended for the measurement, while otherwise the machine produces more quickly.

The number and position of the measurements for parallelism and roundness can be parameterized. This allows a good compromise to be made between the time required for the measurement and the benefits.

The pass characteristic of the measurement filter and the type of measurement filter can be parameterized to allow adaptation to the respective workpiece and matching to a precision measurement room.

Besides an evaluation of the parallelism over the entire bore, an additional evaluation in the upper and lower part of the bore is possible. This offers advantages, as it facilitates, for example, a correction of the bore shape by adjusting the reversal points of the oscillation.

In addition to the evaluation of parallelism, roundness and other shape characteristics, it is also possible with the mathematical methods to determine characteristics according to the standard DIN EN ISO 14405-1 (Geometrical product specification (GPS)—Dimensional tolerancing—Part 1: Linear sizes) such as the largest inscribed size “GX.” This measure corresponds to the diameter of the largest circle that can be placed within the measurement values.

1-16. (canceled)

17. A finishing method for material-removing finishing of a bore in a workpiece on a finishing machine, wherein a finishing tool removes material from the inner surface of the bore in a finishing operation and a shape measurement of the inner surface of the bore is performed on the finishing machine before, during and/or after the finishing operation, the method comprising introducing a measuring tool into the bore and generating a relative movement between the measuring tool and the workpiece,
detecting geometry-relevant measurement values by the measuring tool, and
evaluating the measurement values in an evaluation operation to ascertain at least one shape measurement value describes the macro shape of the bore inner surface,
wherein the evaluation operation comprises:
filtering the measurement values generated by the measuring tool using a filter criterion and at least one filter parameter to ascertain filtered measurement values;
performing a curve fitting on the filtered measurement values to ascertain at least one fitting element adapted to the filtered measurement values in a reference element selected from the group consisting of reference circle, reference line, reference cylinder, reference cone, reference sphere and a combination of rotationally symmetrical portions of at least two of the reference elements;
ascertaining the shape measurement value using at least one geometric property of the fitting element; and
further processing the shape measurement value to operate the finishing machine.

18. The finishing method as claimed in claim 17, wherein a cutoff wavelength or the curvature of an interpolation curve is used as filter criterion.

19. The finishing method as claimed in claim 17, wherein at least one of the workpiece is clamped in a workpiece holding device of the finishing machine for the measurement, and the workpiece is still during the measurement and the measuring tool is moved.

20. The finishing method as claimed in claim 17, wherein a transport between a machining station and a measuring station of the finishing machine separate therefrom takes place between the finishing and the measuring, and the workpiece remains clamped in the workpiece holding device.

21. The finishing method as claimed in claim 17, wherein the further processing comprises at least one of:
displaying an ascertained shape measurement value visibly to an operator;
digitally storing the ascertained shape measurement value together with other workpiece-specific data in a memory unit;
modifying parameters of the control of the finishing operation on the basis of the shape measurement value; and
classifying the measured workpiece, wherein, in classification as a bad part, the workpiece is automatically ejected from a production process.

22. The finishing method as claimed in claim 17, wherein a roundness measurement to ascertain measurement values along a circumferential direction in at least one measurement plane and ascertaining a roundness value from the measurement values, and/or the roundness measurement comprises a rotation of the measuring tool about a measuring tool rotation axis during the measuring operation.

23. The finishing method as claimed in claim 22, wherein the ascertaining of the roundness value a fitting circle is calculated by the filtered measurement values (FMW) and a smallest radius and a largest radius relative to the center (ZAK) of the fitting circle are determined, and/or the roundness value (RUND) is a difference between the largest and the smallest radius.

24. The finishing method as claimed in claim 17, wherein a straightness measurement comprises an axial movement of the measuring tool parallel to a measuring axis during the measuring operation to ascertain measurement values along an axis-parallel generatrix and an ascertaining of a straightness value from the measurement values.

25. The finishing method as claimed in claim 17, wherein at least one of:
cylindricity measurement ascertains a cylindricity value;
parallelism measurement ascertains a parallelism value from straightness measurements at two diametrically opposed generatrices of the bore; and
cone measurement ascertains a cone value or a cone angle of the bore or in a conical portion of the bore.

26. The finishing method as claimed in claim 17, wherein a diameter measuring tool with at least one pair of diametrically opposed measuring probes is used as the measuring tool, or as a pneumatic measuring tool.

27. The finishing method as claimed in claim 17, wherein the ascertaining of a temporal development of at least one shape measurement value by offsetting at least two similar measuring operations is performed at different times.

28. The finishing method as claimed in claim 17, wherein, in an operating mode associated with the shape measurement, an operator query for entering at least one item of information suitable to set up the shape measurement is generated at an operator control device of the finishing machine, and wherein one or more queries are generated:
a desired measuring mode is selected from the following group: cylindricity measurement, roundness measurement, parallelism measurement, straightness measurement, conicity measurement, bellmouth or constriction measurement; and
a filter criterion including Gaussian filter or spline filter, and a matching filter parameter.

29. A finishing machine that finishes a bore in a workpiece comprising:
at least one work station having a tool carrier that carries a tool and a workpiece holding device that holds the workpiece in a working position of the work station;
a control device that controls working movements of the tool carrier and/or the workpiece holding device;
a measuring system that performs a shape measurement of the bore inner surface, wherein the measuring system has a measuring tool that can be inserted into the bore for detecting geometry-relevant measurement values, and the measuring tool is coupled or can be coupled to the tool carrier and can be moved relative to the workpiece by generating a relative movement between the measuring tool and the workpiece carrier; and
an evaluation device that evaluates the measurement values detected by the measuring tool in an evaluation operation to ascertain at least one shape measurement value describing the macro shape of the bore inner surface;
wherein the evaluation device is configured in at least one evaluation mode to perform steps in an evaluation operation:
filtering the measurement values generated by the measuring tool using a predefined or predefinable filter criterion to ascertain filtered measurement values;
performing a curve fitting on the filtered measurement values to ascertain at least one fitting element adapted to the filtered measurement values in a reference element, at least one selected from the group consisting of reference circle, reference line, reference cylinder, reference cone, reference sphere and a combination of rotationally symmetrical portions from at least two of the reference elements;
ascertaining the shape measurement value using at least one geometric property of the fitting element; and
processing the shape measurement value to operate the finishing machine.

30. The finishing machine as claimed in claim 29, wherein the work station has as tool carrier a movably mounted work spindle that can be rotated about a spindle axis by a rotary drive and moved parallel to the spindle axis by a linear drive.

31. The finishing machine as claimed in claim 29, wherein an operator control device that operates the finishing machine, in in an operating mode belonging to the shape measurement an operator query that enters at least one item of information suitable for setting up the shape measurement can be generated, and one or more queries can be generated;
a desired measurement mode selected from the group consisting of: roundness measurement, straightness measurement, cylindricity measurement, parallelism measurement, conicity measurement, eccentricity measurement, and bellmouth/constriction measurement or linear combinations thereof;
at least one filter criterion including a Gaussian filter or spline filter, and a matching filter parameter, and/or at least one cutoff wavelength.

32. The finishing machine as claimed in claim 29, wherein the finishing machine has at least one of a machining station or a honing station, and a measuring station separate therefrom, wherein a transport device is provided for the automated transport of the workpiece between the machining station and the measuring station.
